(19) United States
(12) Patent Application Publication
(10) Pub. No.: US 2014/0320645 A1
(43) Pub. Date: Oct. 30, 2014

(54) Method for Detecting and Documenting the Speeds of a Plurality of Vehicles in an Image Document

(71) Applicant: JENOPTIK Robot GmbH, Monheim (DE)

(72) Inventor: Ralf SCHMITZ, Wiehl (DE)

(73) Assignee: JENOPTIK Robot GmbH, Monheim (DE)

(21) Appl. No.: 14/263,204

(22) Filed: Apr. 28, 2014

(30) Foreign Application Priority Data
Apr. 30, 2013 (DE) DE102013104411.5

(51) Int. Cl. H04N 7/18

(52) U.S. Cl. CPC H04N 7/183; H04N 7/188
USPC 348/142

(57) ABSTRACT

The invention is directed to a method for detecting and documenting the speeds of a plurality of vehicles in an image document. The plurality of vehicles drive simultaneously through the measurement zone of a radiation-based, multitarget-capable measuring arrangement. Vehicle-specific measurement data are acquired from the measurement results, and measurement data sets are formed from these vehicle-specific measurement data and stored. One of the vehicles driving at a speed above a limiting value causes a camera to be triggered. An image document in which a speed is displayed so as to be assigned to the imaged vehicles is generated from the image data acquired by the camera and from the last stored measurement data set.

### RELATED APPLICATIONS

The present application claims priority benefit of German Application No. DE 10 2013 104 411.5 filed on Apr. 30, 2013, the contents of which is incorporated by reference in its entirety.

### FIELD OF THE INVENTION

The invention is directed to a method for detecting and documenting the speeds of a plurality of vehicles such as is known generically from EP 2 075 775 B1.

### BACKGROUND OF THE INVENTION

A number of methods are known from the prior art for detecting speeding violations in which a camera is triggered when a vehicle driving at excessive speed (violation vehicle) is detected in order to make a recording of the violation vehicle and acquire image data therefrom.

As concerns application, the methods for detecting speeding infractions and devices suitable for this purpose are distinguished between those in which the measurement zone of a measuring arrangement and the object field of the camera are limited to only one lane of a roadway and those in which the measurement zone and the object field cover a plurality of lanes of a roadway.

Vehicles driving through the measurement zone are measured by means of a measuring arrangement which may be sensors, radar measuring devices, laser measuring devices or video cameras with image processing systems located on or in the roadway. The vehicle-specific measurement data of interest are determined from the measurement results so as to be associated with the vehicles.

Measuring arrangements which are used for detecting a plurality of lanes are capable of detecting a plurality of vehicles simultaneously such that these vehicles can be distinguished from one another based on the vehicle-specific measurement data and can be processed separately. Aside from vehicle speed and the distance from the measuring arrangement, these multitarget-capable measuring arrangements also supply as vehicle-specific data of interest the angle with respect to an axis defined by the measuring arrangement. In this way, vehicles driving particularly on different lanes and also next to one another can be detected simultaneously and so as to be distinguishable from one another.

While driving through the measurement zone, the vehicles are detected by individual measurements at a plurality of temporally successive measurement times. Further specific vehicle data such as the course of the detected vehicles or the length of the vehicles can be derived from the measurement results of a plurality of temporally successive individual measurements which supply a measurement data set for each vehicle so that the vehicles can be reliably distinguished from one another. But mainly, a plurality of individual measurements are required in order to detect vehicles and to verify measured speeds. The verified speed is then compared with a predetermined limiting value. This can happen when a trigger line is reached or also before the measured vehicle reaches a trigger line. In the former instance, the camera is triggered directly after an excessive speed has been determined through comparison. In the latter instance, a prediction is made based on knowledge of the excessive speed as to when the vehicle reaches the trigger line and the camera is triggered after a delay at the predicted time. A vehicle causing the camera to be triggered is the identified violation vehicle and the measurement data set last associated with this identified violation vehicle is stored along with identification data such as date, time, location and device identification of the measuring arrangement. In so doing, the simultaneously acquired measurement data sets of further vehicles are ignored and not further evaluated if these further vehicles did not reach the trigger line at the same time. Generally, a virtual trigger line which is always at the same distance from the camera is associated with each lane.

When the camera is triggered, the identified violation vehicle, possibly together with other vehicles located in the object field of the camera, is recorded in an image recording and the acquired image data are stored.

According to the prior art, the measurement data set of the identified violation vehicle and the relevant image data for displaying the violation vehicle are stored in correlation with one another as image data set. It is possible to unambiguously assign the vehicle-specific data of the identified violation vehicle which are contained in the measurement data set to the image data of the identified violation vehicle which are stored in the image data set because the measurement of the violation vehicle and the image recording thereof are mutually linked processes having a known temporal correlation with one another as was explained.

It is not important at what time a measurement data set and the image data or only the image data of the identified violation vehicle, i.e., the image data set, are assigned to one another. They can be compiled immediately after data acquisition or at a later time and stored together as a vehicle data package. As proof of the traffic violation, the image data or the image data set and measurement data set of the identified violation vehicle and the stored identification data such as date, time, location and device identification of the measuring arrangement are printed out or displayed as an image document with an image and a superimposed data line.

This type of data utilization and data display has proven disadvantageous for solutions in which a plurality of vehicles can be measured simultaneously.

After the camera has been triggered by a first identified violation vehicle, the camera is not ready to be triggered by a second identified violation vehicle for the duration of a downtime period. This downtime period corresponds at a minimum to the processing time of the camera but may also be considerably longer in case subsequent recordings are initiated by a first image recording.

There are no image recordings, i.e., also no image data set to be assigned, for vehicles that are likewise identified as violation vehicles during this resulting downtime period of the camera. This means that these traffic violations are not penalized.

Further, it has proven disadvantageous when a plurality of vehicles are detected in the image data set in wave beam-based measuring methods because, time and again, testifying drivers or vehicle owners contend that the image recording (violation image) was triggered by a vehicle other than their own.

An obvious solution to this problem would be to install a camera for every lane which would then be activated when detecting a violation to be associated with this lane. However, this would lead to higher costs for the operator for procurement, installation and maintenance.

European Patent EP 2 075 775 B1 discloses a method for the documentation of virtually simultaneous traffic violations which remedies the problem that no image recordings can be taken of further identified violation vehicles during the downtime period of the camera. This is accomplished in that measurement data are acquired for vehicles passing through a measurement zone covering a plurality of lanes. As in the prior art, the measurement data acquired for a first vehicle are stored at a first measurement time and a camera is triggered at a recording time having a known time correlation with the first measurement time. The image recording and the image data acquired thereby are assigned to the measurement data of the first vehicle. According to the above-cited patent EP 2 075 775 B1, however, the acquired image data are then duplicated and also assigned to the measurement data of further measurement times and detected vehicles, respectively, when the latter occur within a predetermined time interval after the first measurement time. In this way, a vehicle data package can be formed for each vehicle using the same image data by means of the image data acquired in an image recording and the measurement data of the detected vehicles (referred to herein as measurement data package). In this case, in practice, an image document showing an identical scene can be stored and, if necessary, printed out for each vehicle data package. The identification data such as date, time and device identification particulars are then identical in the superimposed data line. However, different vehicles which are imaged in the scene are identified in the individual image documents, e.g., by the indication of a lane in the data line and the speed of the respective identified vehicle.

Only the information for one of the imaged vehicles is correspondingly given in these image documents. The described method requires a relatively high expenditure on computation and/or storage in particular because of the duplication of the image documents. Further, there is still the problem of drivers or vehicle owners contending that the violation image was triggered by a vehicle other than theirs.

### SUMMARY OF THE INVENTION

It is an object of the invention to provide a method by which all of the vehicles detected simultaneously by measurement can be documented when there is a traffic violation detected by measurement.

This object is met for a method for documenting speeds of a plurality of vehicles driving on a roadway simultaneously in which vehicle-specific measurement data which include speeds and distances are acquired at a plurality of measurement times from vehicles simultaneously driving through a measurement zone of a radiation-based, multitarget-capable measuring arrangement, which measurement zone covers a plurality of lanes of a roadway, and are stored as measurement data sets so as to be correlated with measurement time and vehicle as soon as the vehicles can be identified based on the measurement data.

When one of the vehicles reaches a trigger point, the speed of this vehicle is compared with a limiting value and if the speed is determined to be above the limiting value the relevant vehicle is identified as violation vehicle. In such cases, a camera is triggered and an image recording is prepared with an image of the violation vehicle. The last measurement data set of the violation vehicle that was previously stored is stored together with an image data set acquired by the image recording and with identification data such as date, time, location and identification of the measuring arrangement as a data package. An image document in which the speed of the violation vehicle is displayed so as to be assigned to the image of the violation vehicle is generated from the data package.

It is an important feature of the invention that the last stored measurement data sets of the simultaneously detected and identified vehicles are also stored so as to be associated with the data package. In this way it is possible to assign speeds to the images of simultaneously detected and identified vehicles shown in the image recording and to display them in the image document such that they are associated with the images.

In an advantageous manner, the speed of the simultaneously detected and identified vehicles is displayed so as to be associated with the images of the simultaneously detected and identified vehicles only when the vehicle's measurement data set which is stored with the data package includes a distance from the measuring arrangement or from the trigger line that lies below a predefined threshold value when the camera is triggered. To this end, the distances in the stored measurement data sets are compared with a predefined threshold value. This threshold value is advantageously a distance in which, for example, a license plate is still visually legible with the naked eye in the image document. In an advantageous manner, the speeds of all of the stored measurement data sets of the simultaneously detected and identified vehicles can be compared with the limiting value, and the speed of the simultaneously detected and identified vehicles is displayed so as to be associated with the images of the simultaneously detected and identified vehicles only when the speed exceeds the limiting value.

The speeds are advantageously represented as numerical values which respectively cover at least partially an image of a vehicle in the image document. The numerical values should be displayed in red when the speed exceeds the limiting value and in green when it lies below the limiting value.

For documentation showing even more visual evidence, the lane on which the vehicles travel is derived from the vehicle-specific measurement data of the measurement data sets stored with the data package and an identification for the respective lane is displayed so as to be associated with the speed.

### BRIEF DESCRIPTION OF THE DRAWINGS

The method will be described by way of example in more detail in the following with reference to the drawing. The drawing shows:

FIG. 1 is an image document.

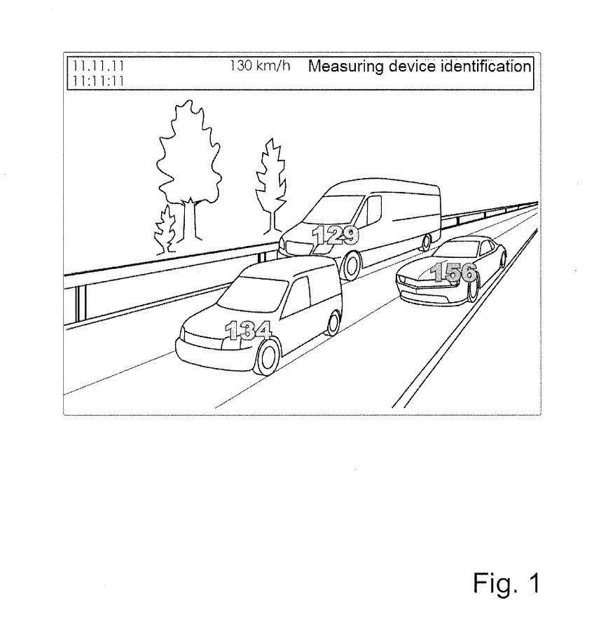

### DESCRIPTION OF THE EMBODIMENTS OF THE INVENTION

To carry out the method, a multitarget-capable, wave beam-based measuring arrangement such as is known from the prior art and which operates in the manner described in the preceding is aligned with respect to a roadway such that its measurement beam covers a plurality of lanes. While passing through a measurement zone formed in this way, the vehicles are detected by individual measurements at a plurality of successive measurement times. A measurement data set with vehicle-specific measurement data can be derived from the measurement results for every measurement time and for every vehicle.

The earliest measurement time at which a measurement data set can be stored is determined by the verification of the vehicle-specific measurement data of a vehicle. It is given when it is possible to derive a model for a vehicle from the obtained measurement results and a speed can be assigned to this model. A vehicle for which complete measurement data are available, which may be referred to as measurement data set, is designated as an identified vehicle.

Multitarget-capable measuring arrangements such as laser scanners and tracking radar sensors are capable of simultaneously tracking models of a plurality of vehicles and directing the vehicle-specific measurement data thereof, as a measurement data set, to an evaluating device at any time or at a predefined trigger time. In so doing, the measurement data sets can supply all of the relevant vehicle-specific measurement data of the trajectory (data relevant to position and movement) such as the vehicle speed, acceleration, distance from the measuring arrangement and also the angle relative to an axis defined by the measuring arrangement.

A selected position can be configured as predefined trigger time for conveying a measurement data set. This may be the position of an actual supporting structure on the roadway as well as any selected position that is parameterized in the measuring arrangement as virtual trigger line. Usually, at least one virtual trigger line is parameterized for each lane. When an identified vehicle reaches the virtual trigger line, the speed of the identified vehicle is compared with a limiting value. If the speed exceeds the limiting value, this vehicle is an identified violation vehicle and an image recording (violation photo) is triggered and an image data set is produced and stored. Further, the measurement data sets of the other possible measured and identified vehicles of the last measurement time which are available at this time are conveyed to the evaluating device. Instead of a position, a time which is determined from the detected speed of an identified violation vehicle as a prediction for reaching a predetermined position or which is reached after a predetermined delay time can be configured as predefined trigger point.

If the trigger point is to be reached after a given delay time, this delay time should be longer than the downtime period during which the camera, after having been triggered, cannot be triggered again and can at a maximum be so long that the identified violation vehicle is still located in the object field of the camera. The measurement zone and the object field are coordinated with one another with respect to position such that the identified violation vehicle is located at an imaginary virtual trigger line (photo line) at a predetermined distance from the camera after a delay time which is within the indicated limits and which is therefore suitable. The delay time is accordingly variable within feasible speed tolerances. It could also be preset in relation to a large depth of field range of the camera, although this would entail the drawback that at different speeds the respective identified violation vehicle would be imaged in the image documents at a different distance from the camera and, therefore, in different sizes because of the distances covered differently within a fixed time frame. It would also be disadvantageous that this preset delay time may be no longer than is sufficient to still capture the violation vehicle traveling at a maximum conceivable speed. Since other identified vehicles generally drive behind the identified violation vehicle as the case may be, they will also necessarily still be located in the object field of the camera.

The invention is based on the idea that, in addition to the speed of the identified violation vehicle, the speeds of the other measured and identified vehicles are also to be documented in an image document. This assumes that the stored image data from which the image document is generated contain image data of all identified vehicles for which a measurement data set has been stored. Moreover, the measurement data sets must contain the complete measurement data allowing a confirmed speed to be assigned to the imaged vehicles and allowing them to be identified within the image recording which is made when the camera is triggered.

In order for all of the vehicles for which a measurement data set has been stored to be captured in the image recording, the object field of the camera must be arranged with respect to the measurement zone of the measuring device in such a way that all of these identified vehicles are located in the object field at the time that the camera is triggered. In particular, these are the vehicles traveling on other lanes at the same height as or just behind the identified violation vehicle causing the camera to be triggered.

The conveyed measurement data sets are stored together with identification data such as date, time, location and measurement device details and together with the image data of the image recording as a data package. An image document is generated from the data package, and the identification data and vehicle-specific measurement data of all identified vehicles are superimposed in the image document in the scene captured in the image recording. Apart from speed, these vehicle-specific measurement data can also be, for example, the lane on which a vehicle travels.

The speeds are advantageously displayed on the image of the associated vehicle as numerical values. For added security, the number of a lane, for example, in the form of a numerical value, particularly with an added letter, e.g., “L” representing the first letter of the English word “lane”, could be displayed on the image of the associated vehicle in addition to the speed.

Advantageously, the speeds of the displayed vehicles in excess of a predetermined limiting value are displayed in red and the permissible speeds below the limiting value are displayed in green.

In order to carry out the method, a camera and a wave beam-based measuring device, e.g., a radar device or a laser scanner, are positioned so as to be aligned with respect to one anther and with respect to the roadway.

In so doing, the object field of the camera and the measurement zone of the measuring device must be arranged with respect to the roadway and with respect to one another such that the object field covers all lanes over the width of the roadway which are also covered by the measurement zone. All lanes in a driving direction are advantageously covered by the measurement zone. Over the length of the roadway, the object field can advantageously be located behind the measurement zone, partially behind the measurement zone or in the measurement zone with reference to the driving direction. It should at least start within the measurement zone where a vehicle driving in the measurement zone is generally identified so that the last identified vehicle is also imaged when the identified violation vehicle has reached the photo line.

If the object field is arranged with respect to the measurement zone such that a vehicle enters the object field immediately after all of the measurement data for identifying the vehicle are available, this ensures that there will be complete measurement data on all of the vehicles imaged in the image document so that a verified speed can be assigned to each imaged vehicle.

The measuring arrangement is advantageously oriented with respect to the roadway such that vehicles traveling toward the measuring arrangement drive through the measurement zone for a long time or enter the measurement zone already at quite a great distance from the measuring arrangement. This is the case particularly when the measuring arrangement is arranged above a straight roadway. In this case, an identified vehicle at the time of identification is still located relatively far from the measuring arrangement and from a virtual trigger line (photo line) which would cause the camera to be triggered when reached. Further vehicles can be identified before this identified vehicle has reached the photo line which is compulsorily located in the object field of the camera. In order to ensure that this also appears in the image, the object field must extend far enough into the measurement zone to include a location at which a vehicle is identified at the earliest.

The method is particularly suitable for monitoring traffic scenes with a high volume and density of traffic in which a plurality of vehicles commonly drive next to one another and close behind one another.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A method for documenting speeds of a plurality of vehicles driving on a roadway simultaneously, wherein vehicles simultaneously drive through a measurement zone of a radiation-based, multitarget-capable measuring arrangement, which measurement zone covers a plurality of lanes of a roadway, and vehicle-specific measurement data which include speeds and distances are acquired at a plurality of measurement times and are stored as measurement data sets so as to be correlated with measurement time and vehicle as soon as the vehicles can be identified based on the measurement data, comprising the speed of the vehicles comparing a limiting value when a trigger point is reached, and identifying the vehicle as a violation vehicle if the speed is determined to be above the limiting value, triggering a camera or recording device, producing an image recording with an image of the violation vehicle, storing the last measurement data set of the violation vehicle that was previously stored together with image data acquired by the image recording and with identification data such as date, time and location as a data package, and generating an image document in which the speed of the violation vehicle is displayed so as to be assigned to the image of the violation vehicle from the data package, the last measurement data set of the simultaneously detected and identified vehicles that was stored before the triggering of the camera or recording device being stored so as to be associated with the data package, simultaneously detected and identified vehicles are also imaged in the image recording, and the speeds are displayed in the image document so as to be assigned to the simultaneously detected and identified vehicles.

2. The method according to claim 1, wherein the speed of the simultaneously detected and identified vehicles is displayed so as to be associated with the images of the simultaneously detected and identified vehicles only when the vehicle's measurement data set which is stored with the data package includes a distance from the measuring arrangement or from the trigger line that lies below a predefined threshold value when the camera is triggered.

3. The method according to claim 1, wherein the speeds of the stored measurement data sets of the simultaneously detected and identified vehicles are compared with the limiting value, and the speed of the simultaneously detected and identified vehicles is displayed so as to be associated with the images of the simultaneously detected and identified vehicles only when the speed exceeds the limiting value.

4. The method according to claim 1, wherein the speeds are displayed as numerical values which respectively cover at least partially an image of a vehicle in the image document.

5. The method according to claim 4, wherein the displays are in red when the speed exceeds the limiting value and in green when it lies below the limiting value.

6. The method according to claim 4, wherein the lane on which the vehicles travel is derived from the vehicle-specific measurement data of the measurement data sets stored with the data package and an identification for the respective lane is displayed so as to be associated with the speed.
